(19) United States
(12) Patent Application Publication
(10) Pub. No.: US 2013/0337887 A1
(43) Pub. Date: Dec. 19, 2013

(54) Apparatus and Method for a Game with Losing Outcomes Earning Buildable Segments Towards Free Spin Awards

(71) Applicant: Genesis Gaming, Inc., Henderson, NV (US)

(72) Inventors: Steven W. Meistrich, Henderson, NV (US); Scott F. Sims, Las Vegas, NV (US)

(21) Appl. No.: 13/897,741

(22) Filed: May 20, 2013

Related U.S. Application Data
(60) Provisional application No. 61/659,019, filed on Jun. 13, 2012.

(51) Int. Cl. G07F 17/32

(52) U.S. Cl. CPC G07F 17/326
USPC 463/22

(57) ABSTRACT

An apparatus and method for a wagering game with multiple outcomes where losing outcomes award the player with buildable segments that can be added together over a sequence of games to produce free spins. Once a free spin is awarded, the cycle starts over again. The wagering game is offered on electronic gaming machines such as slot machines and video poker machines, but may also be deployed in other forms such as on a general purpose computing device or mobile telephone in stand-alone form or connected to a network, such as the internet.

### RELATED APPLICATION INFORMATION

This application claims priority benefit from U.S. Provisional Application No. 61/659,019, filed on Jun. 13, 2012.

### COPYRIGHT NOTICE

Portions of this disclosure contain material in which copyright is claimed by the applicant. The applicant has no objection to the copying of this material in the course of making copies of the application file or any patents that may issue on the application, but all other rights whatsoever in the copyrighted material are reserved.

### BACKGROUND

Electronic gaming machines (“EGMs”) offer a variety of games such as slot games, video poker games, roulette games, keno games and other types of wagering games that are commonly deployed at a casino for use by players. Play on the EGMs typically requires the player to place a wager on the outcome of the game. The games are programmed with a predefined set of outcomes including one or more winning outcomes and one or more losing outcomes. The player is awarded for a winning outcome and receives no award for a losing outcome.

Historically, the simple format of game play with a predefined set of outcomes has been appealing to players even though there are typically more losing outcomes than winning outcomes. However, game designers, players and operators of games are always striving to find appealing features and game functionality that will generate player excitement and increase, or at least maintain the interest of the player. This is particularly important for a player who hits a streak of losses which usually results in the player leaving the game, and possibly the gaming establishment without further play.

The present invention defines a system and method that overcomes the disadvantages inherent in the play of wagering games by casino patrons. It does so by offering an enticement to the player on a losing outcome. Like other games played on an EGM, the player places an initial wager to play. A random number generator (“RNG”) on the EGM generates an outcome and that outcome is displayed on the EGM display to the player. In the event the outcome is a winning combination, the player is awarded a prize in accordance with the EGM pay table. In the event that the outcome is a losing combination, the player is not awarded a prize. However, in accordance with the present invention, the game awards the player with a buildable segment or a “token” when the player has a losing outcome. When the player accumulates enough buildable segments or tokens, they are awarded a free spin. By accumulating free spins for losing outcomes over a sequence of games, the player will receive additional chances to win even when they have lost.

### BRIEF DESCRIPTION OF THE DRAWINGS

For a better understanding of the present invention, and to show more clearly how it functions, reference will now be made, by way of example, to the accompanying drawings. The drawings show embodiments of the present invention in which:

FIG. 1A shows an electronic gaming machine for playing a game;

FIGS. 1B-1F show computing devices for playing a game;

FIG. 2 shows an electronic gaming machine for playing a game and connected to a network controlled by a server based system;

FIG. 3A shows a group of electronic gaming machines on a network connected to a server based system and an external system;

FIG. 3B shows a group of general purpose computing devices on a network connected to a server based system;

FIG. 4 shows a flow chart of game play where the player builds free spins in buildable segments; and

FIGS. 5A-5C shows screen shots of game play where the player builds free spins in buildable segments corresponding to the game play flow chart of FIG. 4.

### DETAILED DESCRIPTION OF THE INVENTION

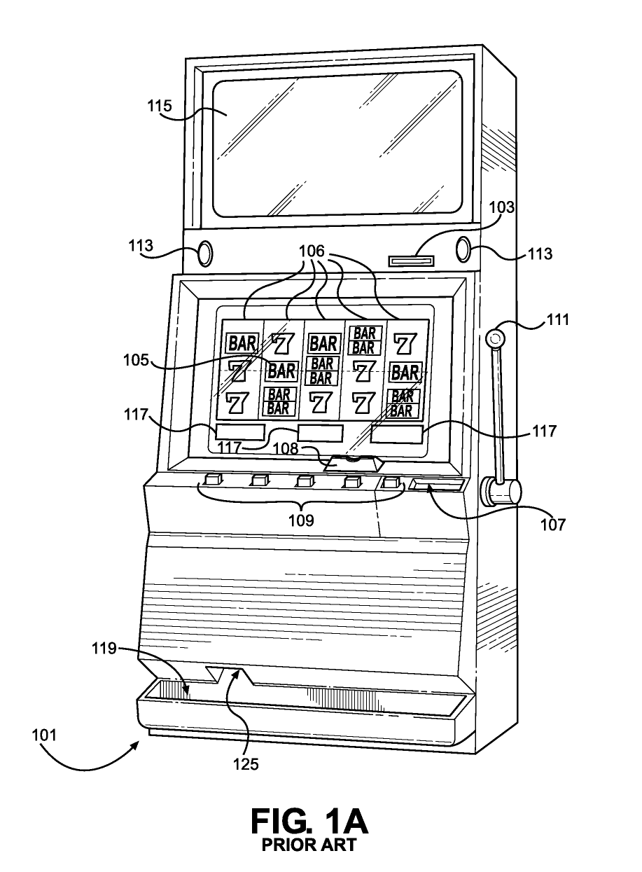

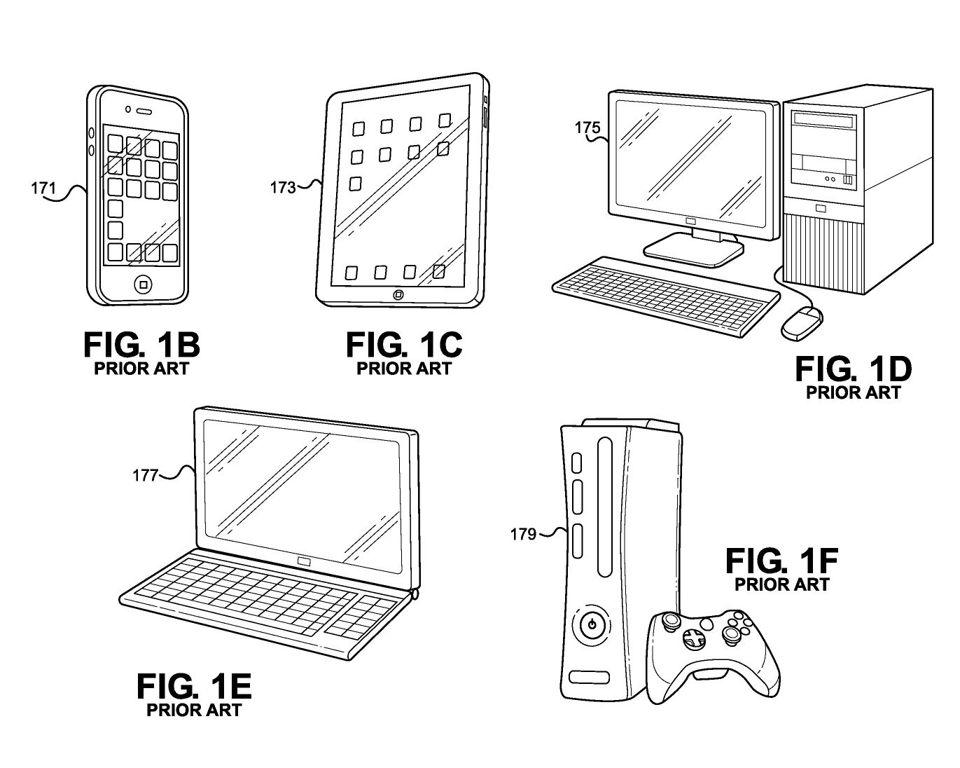

The present invention will now be described more fully with reference to the accompanying drawings. It should be understood that the invention may be embodied in many different forms and should not be construed as limited to the embodiments set forth herein. Throughout FIGS. 1-5, like elements of the invention are referred to by the same reference numerals for consistency purposes.

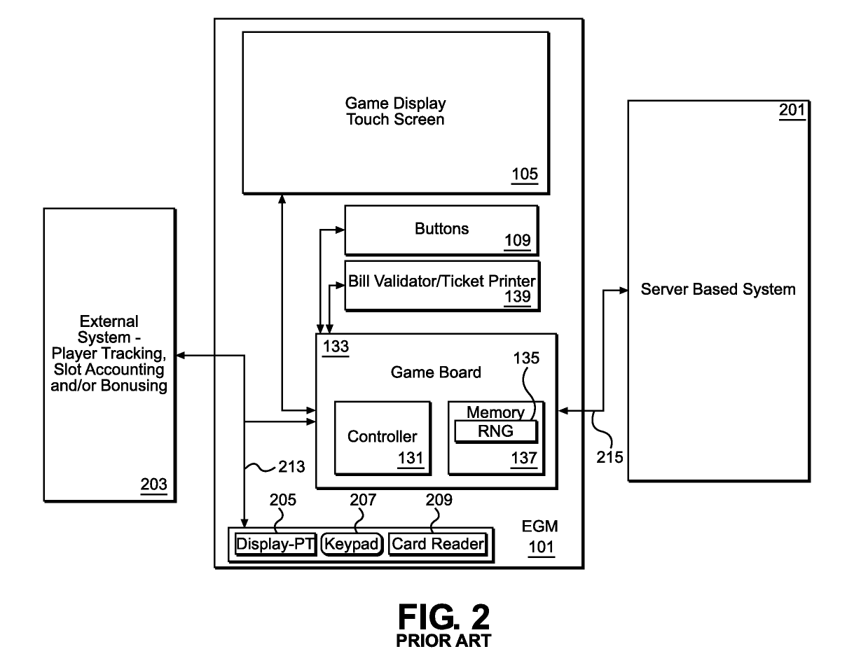

FIG. 1A shows a prior art electronic gaming machine (“EGM”) 101 with a number of components. A display 105 is used to show game play and resulting outcomes, and may be in the form of a video display (shown), or alternatively, physical reels. Touch screen displays are included on most EGMs and provide a flexible interface for operation of EGM 101, including displaying symbols 106 during play. Other components include a bill validator/ticket printer (see FIG. 2) and a coin acceptor that are both housed inside EGM 101 into which bills may be inserted through bill slot 107 and coins may be inserted through coin head 108, respectively. Buttons 109 on the exterior of EGM 101 are used to control certain EGM operations in conjunction with touch screen display 105. A handle 111 may be used to initiate play of a game and speakers 113 are used to provide sounds in conjunction with game play and other EGM operations. EGMs further include a top box 115 for displaying pay tables, artwork, advertising or other types of information either on fixed glass or on other displays such as an integrated video panel. Top box 115 may be fitted with a liquid crystal display (“LCD”) screen to permit aspects of game play from either a base game or a secondary game to be shown in top box 115. Meters 117 for tracking credits available for play, amount won on a particular play, number of coins bet, number of paylines played and other amounts are positioned near the bottom of screen 105. A coin tray 119 at the bottom of EGM 101 is used to catch coins as they are dispensed to a player. It is also common for EGM 101 to include a ticket-in, ticket-out (“TITO”) component that may be part of the bill validator housed inside of EGM 101 that may accept bar coded credits through slot 107 and for which the value of the credits is displayed on meters 117 upon a ticket being inserted. A TITO component may also print and dispense tickets with a bar coded value from EGM 101.

FIGS. 1B-1F show a number of general purpose computing devices which may be used to play a game. These figures show a smartphone 171 in FIG. 1B which may be an Apple iPhone 4S® as pictured, or any other mobile phone type device. A tablet computer 173 is shown in FIG. 1C which may be an Apple iPad 3® as pictured, or any other tablet computing device. A desktop computer 175 is shown in FIG. 1D which may be a Lenovo® machine as pictured, or any other desktop computer. A laptop computer 177 is shown in FIG. 1E which may be a Lenovo® computer or any other laptop computer. And, a home video gaming device 179 is shown in FIG. 1F which may be a Microsoft Xbox® system or any other home video system. Other types of network connected devices could also be used to play games including portable video gaming devices such as a Sony PSP®, a Nintendo GameBoy®, or an internet connected television with a browser or app capabilities. Any of these devices is capable of playing a game, including a wagering game, through an app loaded onto the device or through a website accessible using a browser on the device. In the case of the networked game, payment may be made by credit card, Paypal® or another payment service. The RNG is run securely on server based system 201 (See FIG. 2) and then delivers the outcomes over the internet to be displayed on the general purpose computing device. It should also be understood that the game may be played for fun without a wager, or using promotional or “fun” credits that do not have monetary value.

FIG. 2 is a block diagram of EGM 101 connected to a server based system 201 and showing certain internal components of EGM 101. All operational functions of EGM 101 are controlled by a controller 131 such as a microprocessor housed inside EGM 101 that is resident on a game board 133. The controller executes instructions that include operation of a random number generator 135 (“RNG”) that is usually implemented in software and stored in a memory 137. The internal components of EGM 101are well known to those of ordinary skill in the art. Game outcomes are determined based on the results corresponding to the numbers selected by RNG 135. A bill validator 139 also has ticket printing capabilities. Bill validator 139 accepts currency in the form of bills, or tickets from a player and adds credit to meters 117 on EGM 101.

An external system 203 such as a player tracking system, a slot accounting system or a bonusing system may also be connected to EGM 101. These types of systems are typically connected to EGM 101 either through a separate interface board (not shown) or directly integrated with different components of EGM 101 including but not limited to game board 133. A player tracking system may also include other components installed on EGM 101 such as a player tracking display 205, a keypad 207 and a card reader 209. These components allow for direct interaction between external system 203 and the player to receive information from the player on keypad 207 or through information on a card inserted into card reader 209, and to display information to the player on display 205. A network is established between external system 203 and EGM 101 by network connection 213. The network may be connected to all EGMs 101 in a casino or any smaller subset of EGMs 101.

Server based system 201 is also connected to EGMs 101 by a network connection 215 which may be a separate connection or on a connection to the same network as external system 203. Server based system 201 may have one or more individual servers tasked with different functions such as communicating with a player at EGM 101 to fulfill requests, delivering services such as television shows or other content, or a host of other information.

In FIG. 2, EGM 101 is shown as a casino gaming device of the type depicted in FIG. 1A. It should be understood that any one or more of the general purpose computing devices—smartphone 171, tablet computer 173, desktop computer 175, laptop computer 177, or home video gaming system 179 shown in FIGS. 1B-1F—could be placed on a network connected to server based system 201. For purposes of this specification, reference to one or more EGMs 101 in an environment using a limited access intranet of the type typically found in a casino would also apply to one or more general purpose computing devices with a secure connection to a server over the internet and not involving a physical casino property at all, and which may or may not require a wager or payment to play.

It will be understood that the type of network over which data is communicated can be one of several different types of networks including a Local Area Network (LAN), Wide Area Network (WAN), an intranet or the Internet. Other proprietary networks could also be used without departing from the principles of the invention. This would include such networks as a Windows network or an Ethernet network.

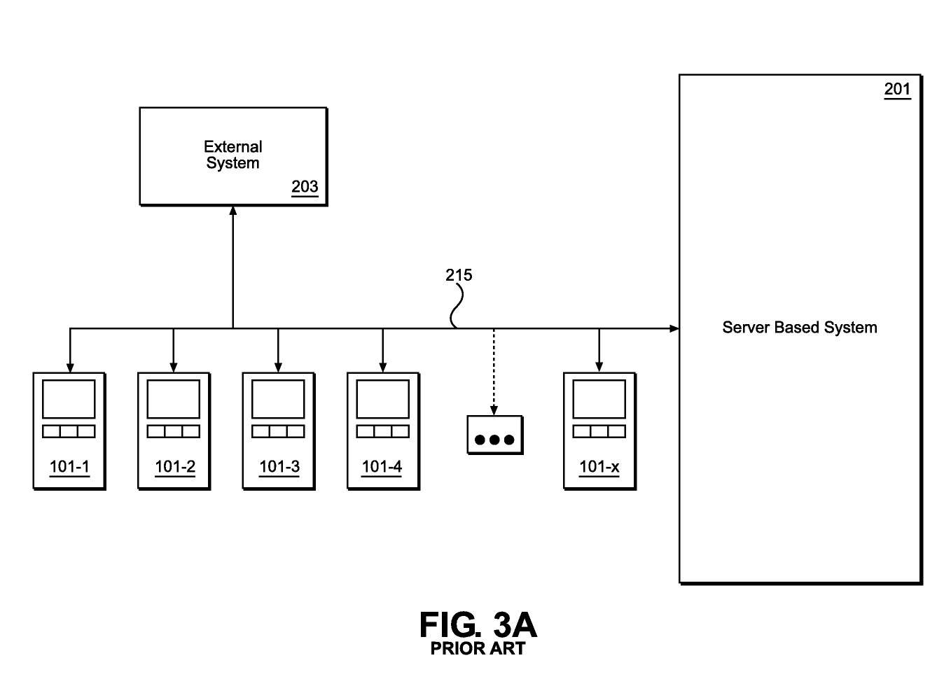

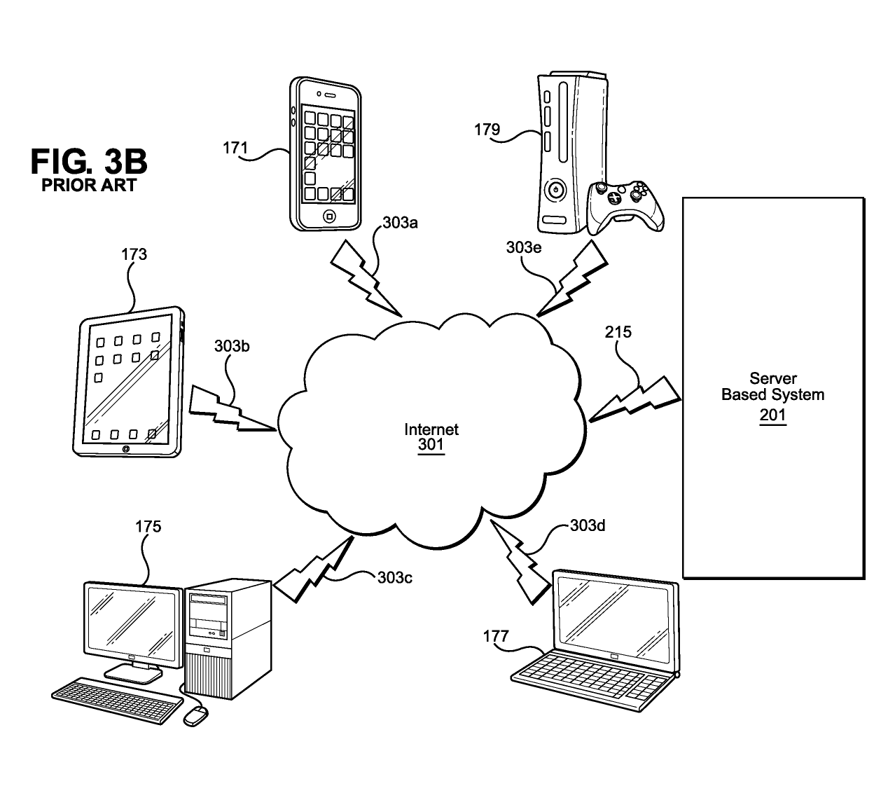

FIG. 3A is a block diagram showing a group of EGMs 101 1-x on a network connection 215 between server based system 201 and each of EGMs 101 1-x. It should be understood that the network may be set up with any number of EGMs that may number into the thousands of machines. Each of EGMs 101 1-x is also connected to external system 203 that may be a player tracking, slot accounting, bonusing or other type of system. Information is communicated between EGMs 101 and server based system 201.

FIG. 3B shows server based system 201 connected to a network with multiple computing devices for playing games. It should be understood that the network shown in FIG. 3B operates in the same manner as the network of FIG. 3A, except that the computing devices on the network of FIG. 3B are connected over the internet 301 with each device 171-179 connected over a secure connection 303a-e to server based system 201 which connects to the internet over network connection 215. Payments can be made securely over internet 301 using connections 303a-e, and then delivered to an operator over connection 215. Similarly, the game is executed on server based system 201 using a secure RNG with the outcomes being delivered to the individual devices 171-179 over internet 301. Alternatively, the game software or a portion of it may be resident and executed on each device 171-179. Wagers by players and payments to players may be made using accounts set up with an operator of a website on which the games are run.

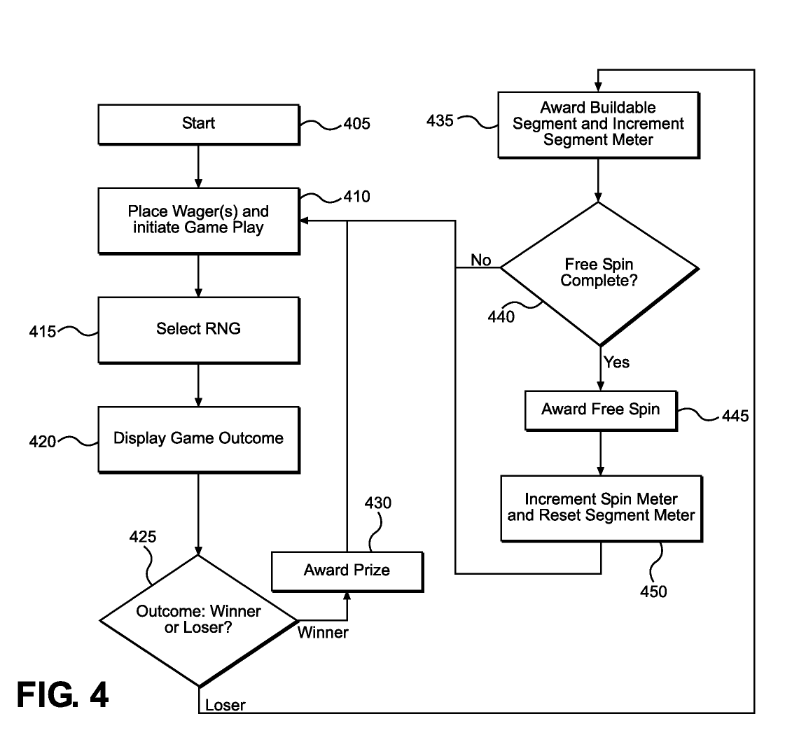

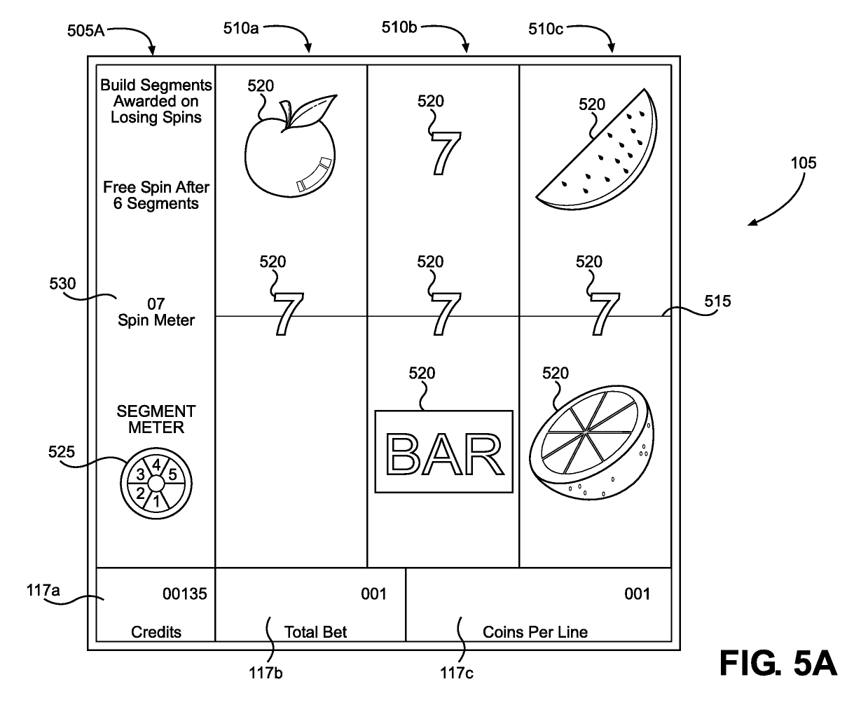

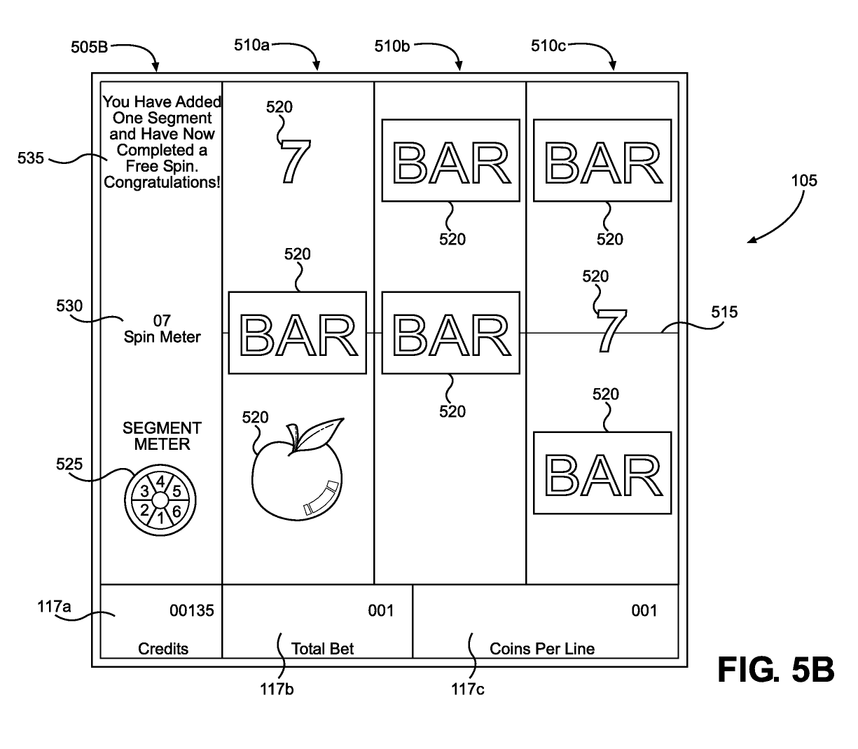

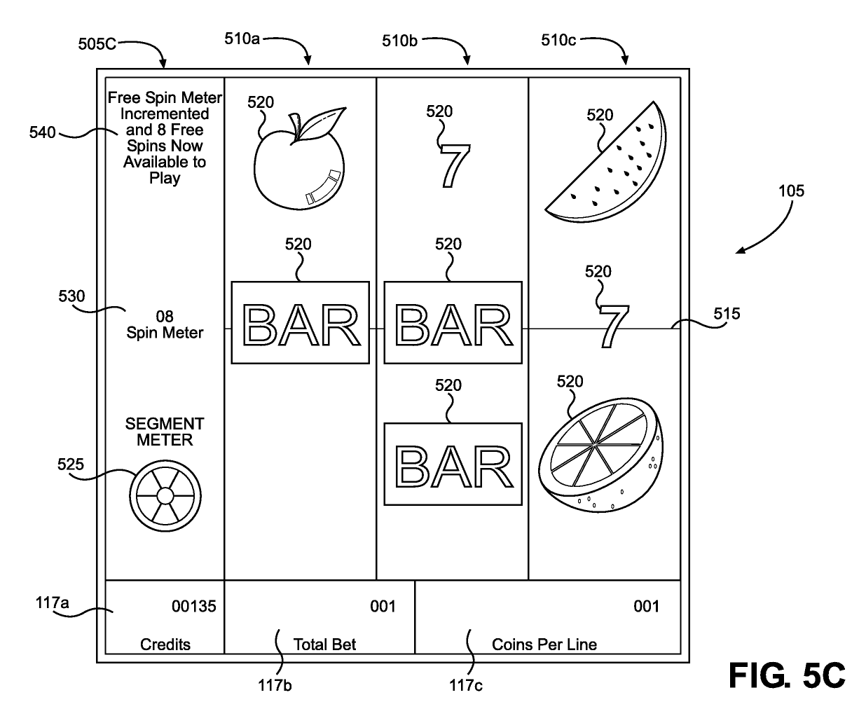

FIG. 4 shows a flow chart of game play in a wagering game where the player earns buildable segments towards one or more free spins, and FIG. 5A-C show corresponding screen shots: a) FIG. 5A—screenshot 505A on display 105 at the start of a game; b) FIG. 5B—screenshot 505B at the end of game play after a losing spin where a segment has been added to complete a free spin build; and c) FIG. 5C—screenshot at the beginning of a new game where the spin meter has been incremented and the segment meter has been reset.

Referring to FIG. 4, start 405 represents the point at which a player sits down at EGM 101 to begin play. The player initially inserts a bill into bill slot 107 or coins into coin head 108 to put credits on the machine. These credits may be displayed to the player on a credit meter 117a. The player then selects the number of lines to play and the number of coins per line which is shown on coins-per-line meter 117c. A “total bet” which depends on the number of lines and the number of coins per line is shown on total bet meter 117b.

For purposes of simplicity and explanation, the description herein refers to a single coin bet on a single payline. However, wagering multiple coins on multiple paylines may reduce the number of plays required to complete a free spin because it would speed up the accumulation of buildable segments where more games are lost more quickly, and in turn, the time it takes to get free spins.

The wager is placed and the game is started using buttons 109 to initiate game play at step 410. An initial game screen is shown in FIG. 5A where free spin meter 530 shows 7 spins and segment meter 525 shows five of six segments completed or earned toward the next free spin. Segment meter 525 is represented as a circle with 6 segments. The screenshots of FIGS. 5A-5C are for a traditional slot game in which the reels spin and stop with symbols lined up on one or more paylines 515. Screenshot 505A shows a previous game that was completed with the outcome shown as a winner with 7-7-7 on payline 515.

During game play, appropriate game graphics are shown on display 105 such as spinning reels 510a-c (or the display of cards to a video poker player), and corresponding game sounds come from speakers 113. In the slot game shown in FIGS. 5A-C, a slot game with common slot symbols 520 (i.e. 7s, BARs, PLUMs, WATERMELONS, ORANGEs and “blanks” are used). Of course, any symbols or combination of symbols may be used for a slot game or any other game embodying the invention where free spins would be replaced with free plays, such as in a poker, keno or roulette game.

At step 415, RNG 135 is executed on controller 131 and a game outcome is chosen. Once the outcome is reached, the outcome is displayed on game display 105 for the player to see at step 420 and as shown on screenshot 505B in FIG. 5B. It is then determined whether the outcome is a winner or loser at step 425. If it is a winning outcome as, for example, it was after play of the game shown in FIG. 5A where 7-7-7 on payline 515 is a winner, the player is notified that s/he has won and is awarded a prize at step 430. An indication on display 105 also shows the win and this may be accompanied by celebratory effects and highlighting of payline 515 and/or symbols 520 on payline 515. Credit meter 117a is incremented by the number of coins won and the player is returned to step 410 to play again.

If it is a losing outcome, the player is awarded a buildable segment reflected by the segment meter 525 being incremented at step 435. In the particular embodiment shown in FIG. 5A-5C, the segment meter is a segmented wheel with six individual segments. In this case, for each losing spin, one of the segments is lit to indicate that it has been “built” or “filled.” At step 440, it is determined whether all of the segments in segment meter 525 have been lit. If not, the player is returned to step 410 to play again. If all of the segments on segment meter 525 have been lit, the player is notified that s/he has won a free spin at step 445. As can be seen in FIG. 5B, after a losing spin of BAR-BAR-7, segment 6 of segment meter 525 has been lit. An indication 535 on display 105 informs the player that a segment has been added resulting in a free spin being awarded. Indication 535 states “You Have Added One Segment and Have Now Completed a Free Spin. Congratulations!” In addition to the message, celebratory effects may also be shown on display 105 and/or sounds may be provided at speakers 113.

At step 450, spin meter 530 is incremented to indicate to the player that s/he has received a free spin and segment meter 525 is reset as can be seen in FIG. 5C, where segment meter 525 is cleared. A message or other indicators on display 105 may also be provided to ensure the player knows what is happening and to enhance the excitement of the game. An example of such a message 540 is shown in FIG. 5C where it states “Free Spin Meter Incremented and 8 Free Spins Now Available for Play.” In addition to message 540, celebratory effects may also be shown on display 105 and/or sounds may be provided at speakers 113.

It will be understood that segment meter 525 as shown is a representative example for depicting the building of a free spin. Other visual designs could substituted such as other shapes, a temperature gauge, or any other depiction showing segments adding to a whole. Using a shape or icon where a player can visually see the progress towards a free spin builds excitement. It should also be understood that the number of segments needed to build a free spin is a design choice, and directly impacts the paytable of the game. A game designer may use six segments as shown, or more or less. In fact, the number of spins may even be selectable by a player, which would require a dynamic paytable to be implemented for use on the game as changing the number of segments needed for a free spin would require that paybacks for particular outcomes be adjusted to maintain the overall payback percentage of the game.

It is also possible to provide a capability to allow the player to convert free spins or unused segments to cash at the end of a game or session of play. Such functionality could be offered directly on EGM 101.

While the invention has been described with respect to the figures, it will be appreciated that many modifications and changes may be made by those skilled in the art without departing from the spirit of the invention. For example, any particular game incorporating the invention may have a bonus feature that includes additional opportunities to earn segments towards free spins. The base game or the bonus may also provide multipliers depending on one or more symbols appearing on the screen in particular configurations such as scatter pays or wild symbols lined up as specified in a paytable. It's also possible to implement the invention where segments are awarded randomly based on an event such as a coin-in threshold on an individual EGM or a group of EGMs. Any variation and derivation from the above description and drawings are included in the scope of the present invention as defined by the claims.

What is claimed is:

1. An electronic gaming machine (“EGM”) on which a player plays a game with an opportunity to win an award, comprising:
a random number generator (“RNG”) for generating random numbers that determine the outcome of the game and that correspond to a predefined set of game outcomes including winning and losing outcomes;
a display for displaying game play including game outcomes to a player;
a controller which executes the RNG and controls game play on the EGM wherein for each losing outcome, the player is awarded a buildable segment which, when added to other buildable segments accumulated by the player, may be converted to one or more awards; and
a segment meter in communication with the controller which is incremented for each buildable segment awarded to a player.

2. The EGM of claim 1 further comprising an award meter in communication with the controller which is incremented when the segment meter reaches a predefined count wherein the player is entitled to a number of free awards displayed on the segment meter.

3. The EGM of claim 2 wherein the award meter is decremented upon the player using an award.

4. The EGM of claim 2 wherein the segment meter is reset upon reaching the preset count and the award meter being incremented.

5. The EGM of claim 1 wherein the player uses an award at a time from the group comprising: (a) when the award is earned; or (b) at a later time.

6. The EGM of claim 1 wherein the player may convert one or more segments to an award from one or more of the group comprising: (a) cash; (b) one or more free spins on a base game; (c) one or more free spins on a bonus game; (d) one or more free spins on a promotional game; or (e) a non-cash prize.

7. The EGM of claim 1 wherein at least one buildable segment is awarded to a player at a time from the group comprising: (a) a random time during play of the EGM; (b) upon a first threshold amount being wagered on the EGM; and (c) upon a second threshold amount being wagered on a group of EGMs on a network to which the EGM is connected.

8. A method of playing a game on an electronic gaming machine (“EGM”) having a controller that executes a random number generator (“RNG”) and a display, comprising:
initiating play of a game on the EGM;
providing a plurality of game outcomes including at least one winning outcome and at least one losing outcome that are displayed on the display, wherein the losing outcome results in the player being awarded a buildable segment which, when added to other buildable segments accumulated by the player, may be converted to one or more awards;
selecting a random number upon running the RNG on the controller that is converted to one of the plurality of game outcomes;
displaying the game outcome on the display;
determining whether the game outcome is a winning outcome or a losing outcome, wherein if the game outcome is a winning outcome, awarding the player with an appropriate award, and if the outcome is a losing outcome, awarding the player with a buildable segment;
incrementing a buildable segment meter on the EGM; and
awarding a player an award upon the buildable segment meter reaching a predefined count.

9. The method of claim 8 further comprising:
incrementing the award meter when the segment meter reaches a predefined count; and
providing an award to the player as displayed on the award meter.

10. The method of claim 9 further comprising decrementing the award meter upon the player using an award.

11. The method of claim 8 further comprising resetting the segment meter upon reaching the preset count; and
incrementing the award meter.

12. The method of claim 8 further comprising the player using an award at a time among the group comprising: (a) at the time the player earns the award; or (b) at a later time.

13. The method of claim 8 further comprising converting one or more buildable segments or awards to earn one or more from the group comprising: (a) cash; (b) one or more free spins on a base game; (c) one or more free spins on a bonus game; (d) one or more free spins on a promotional game; or (e) a non-cash prize.

14. The method of claim 8 further comprising awarding at least one buildable segment to a player at a time from the group comprising: (a) a random time during play of the EGM; (b) upon a first threshold amount being wagered on the EGM; and (c) upon a second threshold amount being wagered on a group of EGMs on a network to which the EGM is connected.

15. The method of claim 8 further comprising awarding a player a buildable segment for each losing outcome achieved for each payline played during the game.

16. The method of claim 8 further comprising multiplying the number of buildable segments awarded to a player for each losing outcome achieved for each payline played when a multiplier was in effect during the game.

17. A method of playing a game on an electronic gaming machine (“EGM”) having a controller that executes a random number generator (“RNG”) and a display, comprising:
providing a plurality of game outcomes including at least one winning outcome and at least one losing outcome that are displayed on the display, wherein the losing outcome results in the player being awarded a buildable segment which, when added to other buildable segments accumulated by the player, may be converted to one or more free spins;
selecting a random number upon running the RNG on the controller that is converted to one of the plurality of game outcomes;
displaying the game outcome on the display;
determining whether the game outcome is a winning outcome or a losing outcome, wherein if the game outcome is a winning outcome, awarding the player with an appropriate award, and if the outcome is a losing outcome, awarding the player with a buildable segment;
incrementing a buildable segment meter on the EGM; and
awarding a player a free spin upon the buildable segment meter reaching a predefined count.

18. The method of claim 17 further comprising awarding a player a buildable segment for each losing outcome achieved for each payline played during the game.

19. The method of claim 17 further comprising multiplying the number of buildable segments awarded to a player for each losing outcome achieved for each payline played when a multiplier was in effect during the game.

20. The method of claim 17 further comprising providing a selection to the player to select to use the free spin for a spin during one of the group comprising: (a) a base game; or (b) a bonus game.
